(19) United States
(12) Patent Application Publication
(10) Pub. No.: US 2007/0220498 A1
(43) Pub. Date: Sep. 20, 2007

(54) Method, mobile terminal and computer program product for interworking via a card application toolkit

(76) Inventor: Jens Ole Madsen, Frederiksberg C (DK)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/376,590

(22) Filed: Mar. 15, 2006

(51) Int. Cl. H04L 9/00; G06F 9/45

(52) U.S. Cl. 717/140; 705/75

(57) ABSTRACT

A method, computer program product and mobile terminal are disclosed for providing application interworking via a card application toolkit. Initially, a request is received from the card application toolkit to access a requested application, such as a Java MIDlet. A determination is then made as to whether the requested application is registered, such as by searching a registry for an address associated with the requested application. If registered, the requested application is launched. The method, computer program product and mobile terminal can also initially register at least one application, such as by storing an address of the application in a registry. The registration of the application can also include the designation of a port associated with a user identity module (UIM) for connection with an application via a transport control protocol (TCP) socket or a user datagram protocol (UDP) datagram.

### FIELD OF THE INVENTION

Embodiments of the present invention relate generally to mobile terminal technology and, more particularly, relate to a method, apparatus, and computer program product for providing Java or other application interworking via a card application toolkit on a mobile terminal.

### BACKGROUND OF THE INVENTION

In many wireless communication networks and other mobile networks, mobile terminals, such as mobile telephones, are provided with multiple mechanisms by which to open applications for execution at the mobile terminals. In such networks, it is typical for applications to access and utilize various phone features such as calling, sending or receiving short messages, browsing, multimedia messaging, etc.

A card application toolkit (CAT) is currently in use in many mobile terminals. The CAT is an application program interface (API) implemented in the mobile terminal. The CAT may be implemented on a user identity module (UIM) of the mobile terminal, such as, for example a smart card, a subscriber identity module (SIM), a universal integrated circuit card (UICC), a universal subscriber identity module (USIM), a removable user identity module (R-UIM), etc. CATs are currently stored on the UIMs of many mobile terminals and are used to allow applications implemented on the UIM to access and utilize many of the phone features described above. The UIM or smart card is often seen as an advantageous platform for implementing certain applications due to the security inherent in the UIM and the ease of use of the UIM. However, the development of further functionality of CAT applications is slow since many perceive the protocol used between the CAT and the mobile terminal to be inflexible. Accordingly, CAT applications have often been reserved to use with the most basic of features.

As stated above, one complaint among operators is that the existing CAT user interface is not flexible. Accordingly, it is difficult for operators to “brand” their CAT applications to provide highly personalized and thus improved user experience. Meanwhile, another API, that is, a Java API, which is well known in the industry, is extremely flexible and powerful with respect to allowing applications to access phone features. Thus, Java has been widely used by developers to develop increased functionality for mobile terminals. Additionally, other types of applications written for operating systems such as, for example, Windows, Symbian, Unix, BREW, etc. are also commonly used and flexible.

Recently, it has been common for many features implemented on mobile terminals to have double implementation in which the same features are implemented in both a CAT API and a Java API. In an attempt to alleviate this problem, a subset of a Java API, namely JSR 177 has been developed to provide a certain amount of interworking between CAT and Java. JSR 177 allows a Java MIDlet to open a connection to a CAT application on the UIM in order to send data to the CAT application using a special application protocol data unit (APDU) and receive an answer from the UIM. This approach is limited since the APDU cannot exceed a size of 256 bytes, there is a limited time in which the CAT application may answer, and the initiative for sending a message lies entirely with the Java MIDlet.

In order to eliminate the above described problems, there is a need to develop a means by which the security advantages and ease of use offered by CAT applications may be combined with the advantageous flexibility of Java or other applications.

### BRIEF SUMMARY OF THE INVENTION

A method, apparatus and computer program product are therefore provided that enables Java or other application interworking with a CAT application on a mobile terminal. Accordingly, increased flexibility, security and ease of use is afforded to mobile terminal users.

In one exemplary embodiment, a method is disclosed for providing application interworking via a card application toolkit. In this embodiment, the method receives a request from the card application toolkit to access a requested application, such as a Java MIDlet. The method then determines whether the requested application is registered, such as by searching a registry for an address associated with the requested application, and launches the requested application in response to the requested application being registered. If the requested application is unregistered, the method may send a relevant message in response.

The method can also initially register at least one application, such as by storing an address of the application in a registry. The registration of the application can also include the designation of a port associated with a user identity module (UIM) for connection with an application via a transport control protocol (TCP) socket or a user datagram protocol (UDP) datagram.

In another exemplary embodiment, a computer program product is disclosed for providing application interworking via a card application toolkit. The computer program product includes at least one computer-readable storage medium that stores computer-readable program code portions. The computer-readable program code portions include a first executable portion for receiving a request from the card application toolkit to access a requested application, such as a Java MIDlet, a second executable portion for determining whether the requested application is registered, such as by searching a registry for an address associated with the requested application, and a third executable portion for launching the requested application in response to the requested application being registered. If the requested application is determined to be unregistered, the computer program product can include instructions for sending a relevant message in response to that determination.

The computer program product of one embodiment also includes a fourth executable portion for performing an initial step of registering at least one application to a registry, such as by storing an address of the application in the registry. the fourth executable portion can also include instructions for designating a port associated with a user identity module (UIM) for connection with an application, such as a Java MIDlet, via a transport control protocol (TCP) socket or a user datagram protocol (UDP) datagram.

In another exemplary embodiment, a mobile terminal is provided that is capable of communication with a user identity module (UIM) so as to launch applications, such as Java MIDlets, requested by the UIM. In this regard, the mobile terminal includes a memory device maintaining a registry of applications. For example, the memory device can store registrations including addresses associated with the respective applications in the registry. The mobile terminal also includes a processing element capable of receiving a request from the UIM, such as from a card application toolkit of the UIM, to access a requested application, such as a Java MIDlet. The processing element is also capable of accessing the registry to determine whether the requested application is registered. For example, the processing element may be capable of searching the registry for the address associated with the requested application. In addition, the processing element is capable of launching the requested application in response to the requested application being registered. If unregistered, the processing element may be further capable of sending a relevant message in response. Additionally, the processing element may be further capable of registering an application by designating a port associated with the UIM for connection with the application via a transport control protocol (TCP) socket or a user datagram protocol (UDP) datagram.

In an exemplary embodiment, a mobile terminal that is capable of communication with a UICC as an exemplary UIM is provided. A processing element of the mobile terminal may be configured to receive a command from the UICC to launch a requested application. The mobile terminal may then determine whether the requested application is able to be launched.

In an exemplary embodiment, a UIM capable of communication with a mobile terminal is provided. The UIM includes a processing element that may be configured to issue a command for the mobile terminal to launch a requested application. The UIM may then receive information from the mobile terminal indicating whether the requested application is able to be launched.

Embodiments of the invention provide a method, apparatus and computer program product for interworking with a CAT application. As a result, operators may combine the security and ease of use of the UIM with the full power and flexibility of Java or other applications for accessing and utilizing user interface and other device features.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a mobile terminal according to an exemplary embodiment of the present invention; and

FIG. 4 is a block diagram according to an exemplary method of providing Java interworking via a card application toolkit according to one embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

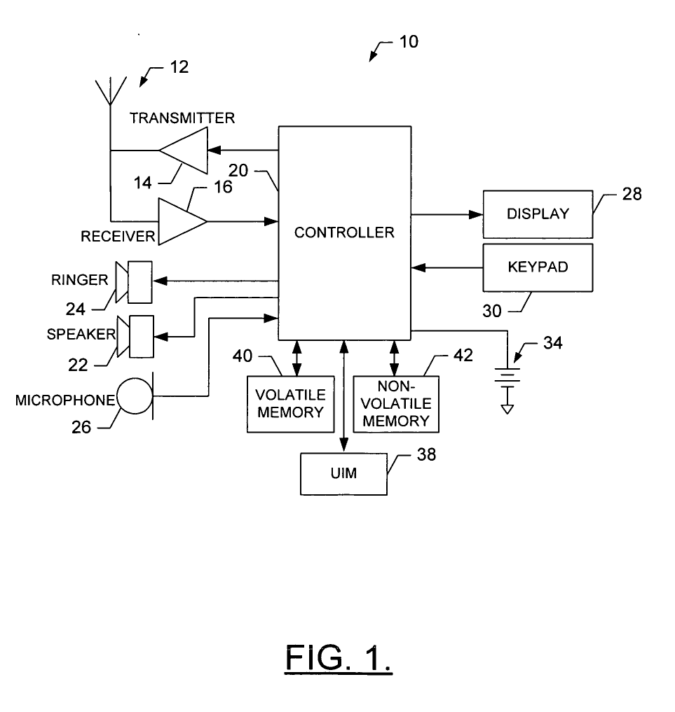

FIG. 1 illustrates a block diagram of a mobile terminal 10 that could embody and would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile television, laptop computers and other types of voice and text communications systems, can readily employ the present invention. Furthermore, it should be understood that, although the present invention will be described in detail with respect to interworking Java applications with a card application toolkit, the present invention may also be practiced with other applications such as, for example, applications written for operating systems such as Windows, Symbian, Unix and BREW, or other native applications.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third generation (3G) wireless communication protocol W-CDMA.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example. Also, for example, the controller 20 may be capable of operating a software application capable of creating an authorization for delivery of location information regarding the mobile terminal 10, in accordance with embodiments of the present invention (described below).

The mobile terminal 10 also comprises a user interface including an output device such as a conventional earphone or speaker 22, a ringer 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

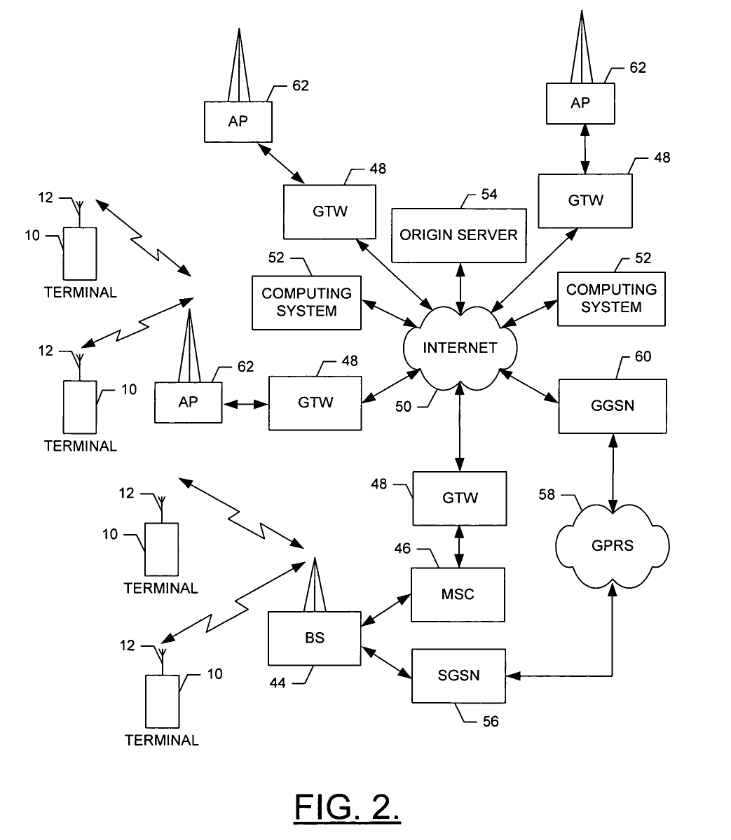

Referring now to FIG. 2, an illustration of one type of system that could embody and would benefit from the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

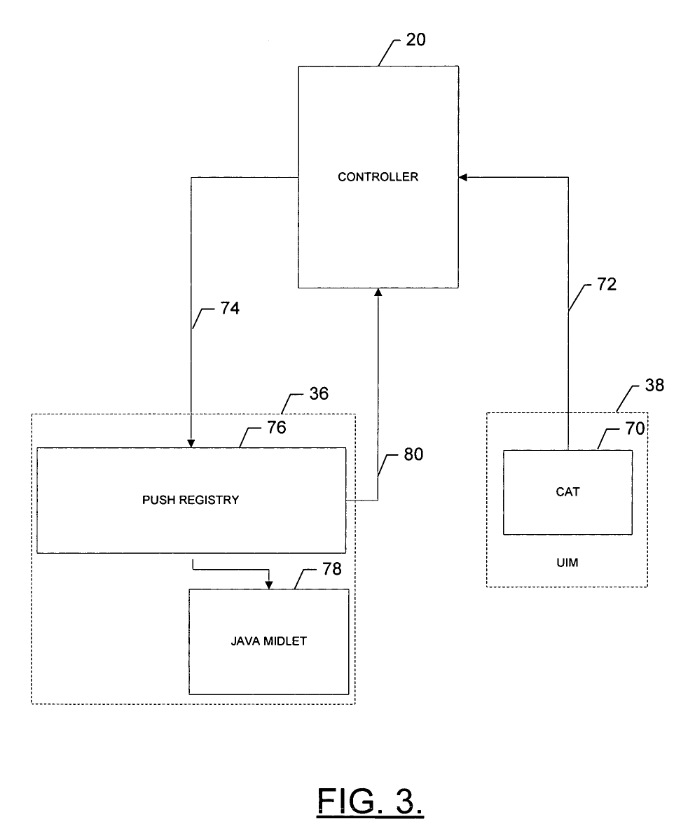

An exemplary embodiment of the invention will now be described with reference to FIG. 3, in which certain elements of the mobile terminal 10 of FIG. 1 are shown in greater detail. It should be noted, however, that while FIG. 3 illustrates merely one example of a configuration of a mobile terminal, numerous other configurations may also be used to implement the present invention. Referring now to FIG. 3, a card application toolkit (CAT) 70 may be stored on the UIM 38. As described previously, the CAT 70 is an application program interface (API) that allows applications implemented on the UIM 38 to access and utilize many features that the mobile terminal 10 is capable of employing. As such, the CAT 70 may send messages to the controller 20 requesting that the controller 20 activate a particular feature. For example, the CAT 70 may activate such features as calling, sending short messages, placing menu items within a structure of the user interface of the mobile terminal 10, etc.

One CAT 70 feature, which allows a CAT application on the UIM 38 to open a connection socket (for transport control protocol (TCP)) or datagram (for user datagram protocol (UDP)) to an external entity such as an Internet server is called Bearer Independent Protocol. According to Bearer Independent Protocol, different bearers are available for connection, including network bearers (for example, GERAN/UTRAN and GPRS) and local bearers (for example, Bluetooth, IrDa and USB). The UIM 38 may send, for example, an address of an external entity, such as an internet address (i.e., an IP address or URL), for connection to the controller 20. The UIM 38 may also send an indication of which bearer to use. As such, Bearer Independent Protocol provides a mechanism by which the mobile terminal 10 may communicate with an external entity. Embodiments of the present invention provide a “virtual bearer” by which the UIM 38 may open a connection to a Java MIDlet or other application by sending a message to the controller 20 of the mobile terminal 10 indicating, for example, an address of the Java MIDlet or other application. Since the UIM 38 may initiate the communication to open the connection to the Java MIDlet or other application, embodiments of the present invention may be practiced even when the mobile terminal 10 has no network connection. The present invention will now be described in detail with respect to an exemplary embodiment in which a connection to a Java MIDlet is opened, although connections to other applications could be made in other embodiments.

In this embodiment, the CAT 70 may send a request 72 to the controller 20 to interface with a Java MIDlet. In response to receipt of the request 72, the controller 20 sends a message 74 to a push registry 76 located in the memory 36 of the mobile terminal 10. The push registry 76 may be, for example, a register of addresses for particular applications. Alternatively, the push registry 76 may be any means by which a particular application is associated with a particular memory location. In an exemplary embodiment, the push registry 76 is a register including addresses, for example, of particular APIs which may be employed when requested. Thus, when the request 72 is sent by the CAT 70, the request 72 may include a call to open a particular Java MIDlet. The controller 20 then sends the message 74 to the push registry 76 to check registrations listed in the push registry 76 to see if the request 72 may be met. If the push registry 76 includes a registration corresponding to the request 72 (i.e., by including a registration for the Java MIDlet), the corresponding Java MIDlet 78 is launched. If the push registry 76 does not include a registration corresponding to the request 72, then a notification 80 may be sent to the controller 20 which may include a relevant message explaining why the request 72 cannot be met. The notification 80 may subsequently be communicated to the UIM 38.

Registration of a particular Java MIDlet to the push registry 76 can be performed when the Java MIDlet is installed, for example, during production of the mobile terminal 10. In such a case, the Java MIDlet may be selected for activation by a user of the mobile terminal 10. Registration of a particular Java MIDlet to the push registry 76 can also be performed subsequent to running the particular Java MIDlet at the mobile terminal 10. For example, the particular Java MIDlet may be downloaded by the user, executed at the mobile terminal, and then registered. As stated above, registration may be accomplished by storing an address associated with the particular Java MIDlet in the push registry 76. However, other mechanisms for registration are also available. For example, the MIDP 2.0 Java specification allows a MIDlet to be registered for inbound connection in a push registry with the format: <ConnectionURL><MIDlet ClassName><AllowedSender>. Thus, in an exemplary embodiment, one or more ports may be registered with the Internet Assigned Numbers Authority (IANA) as UIM ports. For example, if an arbitrarily chosen port such as port 65000 is defined as being a UIM port, then a MIDlet could be registered for a TCP connection using the format: socket://:65000, com.nokia.example.SampleMidlet. As an alternative example, if port 65000 is defined as being a UIM port, then a MIDlet could be registered for a UDP connection using the format: datagram://:65000, com.nokia.example.SampleMidlet. Thus, in order to open a connection to the MIDlet, the CAT 70 may send the request 72 to open a connection to “localhost:65000”. In response to the request 72, the controller 20 sends the message 74 to determine if any registrations are listed for port 65000. In the present example, since port 65000 is registered, the Java MIDlet 78 would be launched. However, if port 65000 was not registered, the notification 80 may include relevant messages, such as an error message, for example, “no MIDlet registered to port”.

When the Java MIDlet 78 is launched, a communication channel is created over which data or information may be sent. The data may be whatever developers of the Java MIDlet 78 define. Additionally, the data may be sent in a completely proprietary format. Furthermore, the Java MIDlet 78 may be an implementation of Java remote method invocation (RMI). As such, all information needed for a method call (unique method name and all parameters) are serialized as a standardized stream of bytes which can be sent over any type of connection, with results being communicated in a similar serialized manner.

As stated above, although the Java MIDlet 78 may be launched in an exemplary embodiment of the present invention, other applications such as, for example, applications written for Windows, Symbian, Unix, BREW, etc., may also be launched. Thus, in general terms, embodiments of the present invention allow the UIM 38 to open a connection to a server in the mobile terminal 10. If a TCP connection is requested, the mobile terminal 10 issues an active OPEN request to the port number given in the command at the localhost IP address (e.g. 127.0.0.1 for IPv4). If a UDP connection is requested, the mobile terminal 10 sends a datagram to the port number given in the command at the localhost IP address (e.g. 127.0.0.1 for IPv4). In both cases the mobile terminal 10 forwards incoming/outgoing data on this port to/from the UIM 38. A TCP or UDP server in the mobile terminal 10 can be any application listening at the indicated port. Accordingly, the UIM 38 is enabled to launch a registered application and to communicate with the registered application using the opened channel.

Upon receiving a command to open a channel, the mobile terminal 10 determines if execution of the command is possible. The UIM 38 indicates whether the mobile terminal 10 should establish a link immediately, in background mode, or upon receiving the first transmitted data (on demand). If immediate link establishment is requested, the mobile terminal 10 allocates buffers, sets up a connection to the indicated port, informs the UIM 38 and reports a channel status using a TERMINAL RESPONSE (Command performed successfully). If on demand link establishment is requested, the mobile terminal 10 allocates buffers, informs the UIM 38 and reports the channel status using TERMINAL RESPONSE (Command performed successfully). If background mode activation is requested, the mobile terminal 10 allocates buffers, starts activation of the connection, informs the UIM 38 and reports the channel status immediately using TERMINAL RESPONSE (Command performed successfully). Following activation, the mobile terminal 10 sends a channel status event (e.g., TCP connection active or TCP connection not active—no further info).

Only one TCP connection can be handled on one bearer independent protocol channel at any point in time. If a second connection in parallel is desired, the UIM 38 may open a second bearer independent protocol channel on the same or a different port. If a TCP disconnect occurs while the bearer independent protocol connection is still open, the mobile terminal 10 may inform the UIM 38 using a channel status event (i.e., TCP connection not active), and wait for a CLOSE CHANNEL command from the UIM 38. If the mobile terminal 10 is unable to process the command a TERMINAL RESPONSE may include an error message or otherwise indicate a reason for the inability to process the command.

In an exemplary embodiment, the mobile terminal 10 is capable of communication with a UICC as an exemplary UIM. A processing element of the mobile terminal 10 may be configured to receive a command from the UICC to launch a requested application. The mobile terminal 10 may then determine whether the requested application is able to be launched. The mobile terminal may then be configured to inform the UICC as to whether the command is able to be executed. The requested application may be, for example, a Java MIDlet. The mobile terminal 10 may receive a request for either a TCP or UDP connection to the requested application. If the TCP connection is requested, the UICC may issue an active OPEN request to a port number given in the command at a localhost internet protocol (IP) address. If the UDP connection is requested, the UICC may issue a datagram to a port number given in the command at a localhost internet protocol (IP) address. In either case, the incoming and outgoing data is communicated between the mobile terminal 10 and the UICC via the port number. Thus, the UICC is capable not only of opening a port connection, but also capable of initiating communication via the port to open or launch an application. In other words, according to this exemplary embodiment, the mobile terminal 10 is in server mode instead of the UICC being in server mode.

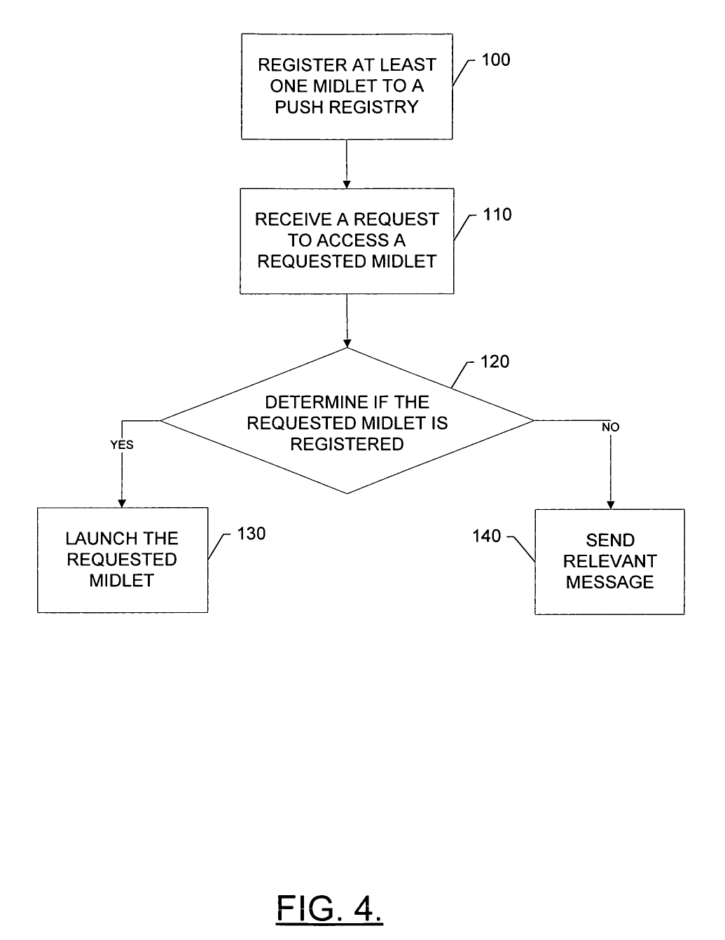

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for implementing interworking via a card application toolkit includes registering at least one Java MIDlet at a push registry at operation 100. At operation 110, a request to access a requested Java MIDlet is received. At operation 120, a determination is made as to whether or not the requested Java MIDlet is registered. If the requested Java MIDlet is registered, then the requested Java MIDlet is launched at operation 130. If the requested Java MIDlet is not registered, then a relevant message is sent at operation 140. As noted above, applications other than a Java MIDIct may be interworked via a card application toolkit in other embodiments.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of providing application interworking via a card application toolkit, the method comprising:
receiving a request from the card application toolkit to access a requested application;
determining whether the requested application is registered; and
launching the requested application in response to the requested application being registered.

2. A method according to claim 1, wherein receiving a request comprises receiving a request for a Java MIDlet.

3. A method according to claim 1 further comprising an initial step of registering at least one application to a registry.

4. A method according to claim 3, wherein the registering comprises storing an address of the application in the registry.

5. A method according to claim 1, wherein the registering comprises designating a port associated with a user identity module (UIM) for connection with an application via one of:
a transport control protocol (TCP) socket; and
a user datagram protocol (UDP) datagram.

6. A method according to claim 1, further comprising sending a relevant message in response to the requested application being unregistered.

7. A method according to claim 1, wherein the determining comprises searching a registry for an address associated with the requested application.

8. A computer program product for providing application interworking via a card application toolkit, the computer program product comprising at least one computer-readable storage medium having computer-readable program code portions stored therein, the computer-readable program code portions comprising:
a first executable portion for receiving a request from the card application toolkit to access a requested application;
a second executable portion for determining whether the requested application is registered; and
a third executable portion for launching the requested application in response to the requested application being registered.

9. A computer program product according to claim 8, wherein the first executable portion is capable of receiving a request for a Java MIDlet.

10. A computer program product according to claim 8 further comprising a fourth executable portion for performing an initial step of registering at least one application to a registry.

11. A computer program product according to claim 10, wherein the fourth executable portion further includes instructions for storing an address of the application in the registry.

12. A computer program product according to claim 10, wherein the fourth executable portion further includes instructions for designating a port associated with a user identity module (UIM) for connection with a Java MIDlet via one of:
a transport control protocol (TCP) socket; and
a user datagram protocol (UDP) datagram.

13. A computer program product according to claim 9, further comprising a fourth executable portion for sending a relevant message in response to the requested application being unregistered.

14. A computer program product according to claim 9, wherein the second executable portion further includes instructions for searching a registry for an address associated with the requested application.

15. A mobile terminal capable of communication with a user identity module (UIM), the mobile terminal comprising:
a memory device maintaining a registry of applications; and
a processing element capable of:
receiving a request from the UIM to access a requested application;
accessing the registry to determine whether the requested application is registered; and
launching the requested application in response to the requested application being registered.

16. A mobile terminal according to claim 15, wherein the processing element is capable of receiving a request for a Java MIDlet.

17. A mobile terminal according to claim 16, wherein the memory device stores registrations including addresses associated with the respective applications including the requested Java MIDlet in the registry.

18. A mobile terminal according to claim 17, wherein the processing element is further capable of searching the registry for the address associated with the requested Java MIDlet.

19. A mobile terminal according to claim 15, wherein the processing element is further capable of sending a relevant message in response to the requested application being unregistered.

20. A mobile terminal according to claim 15, wherein the processing element is further capable of registering an application by designating a port associated with the UIM for connection with the application via one of:
a transport control protocol (TCP) socket; and
a user datagram protocol (UDP) datagram.

21. A mobile terminal according to claim 15, wherein the processing element is capable of receiving the request from a card application toolkit of the UIM.

22. A mobile terminal capable of communication with a universal integrated circuit card (UICC), the mobile terminal comprising:
a processing element configured to:
receive a command from the UICC to launch a requested application;
determine whether the requested application is able to be launched; and
inform the UICC whether the command is able to be executed.

23. A mobile terminal according to claim 22, wherein the processing element is configured to receive a command to launch a Java MIDlet.

24. A mobile terminal according to claim 22, wherein the processing element is capable of receiving a request for one of:
a transport control protocol (TCP) socket connection; and
a user datagram protocol (UDP) datagram connection.

25. A mobile terminal according to claim 24, wherein if the TCP connection is requested, the mobile terminal receives an active OPEN request to a port number given in the command at a localhost internet protocol (IP) address.

26. A mobile terminal according to claim 25, wherein the mobile terminal communicates incoming and outgoing data with the UICC via the port number.

27. A mobile terminal according to claim 24, wherein if the UDP connection is requested, the mobile terminal receives a datagram to a port number given in the command at a localhost internet protocol (IP) address.

28. A mobile terminal according to claim 27, wherein the mobile terminal communicates incoming and outgoing data with the UICC via the port number.

29. A user identity module (UIM) capable of communication with a mobile terminal, the UIM comprising a processing element configured to:
issue a command to the mobile terminal to launch a requested application; and
receive information from the mobile terminal regarding whether the requested application is able to be launched.

30. A UIM according to claim 29, wherein the processing element is configured to issue a command to launch a Java MIDlet.

31. A UIM according to claim 29, wherein the processing element is capable of requesting one of:
a transport control protocol (TCP) socket connection; and
a user datagram protocol (UDP) datagram connection.

32. A UIM according to claim 31, wherein if the TCP connection is requested, the UIM issues an active OPEN request to a port number given in the command at a localhost internet protocol (IP) address.

33. A UIM according to claim 32, wherein the UIM communicates incoming and outgoing data with the mobile terminal via the port number.

34. A UIM according to claim 31, wherein if the UDP connection is requested, the UIM issues a datagram from a port number given in the command at a localhost internet protocol (IP) address.

35. A UIM according to claim 34, wherein the UIM communicates incoming and outgoing data with the mobile terminal via the port number.
